(19) United States
(12) Patent Application Publication
(10) Pub. No.: US 2025/0106935 A1
(43) Pub. Date: Mar. 27, 2025

(54) METHOD AND APPARATUS OF CELL-SPECIFIC OPERATION FOR CELL DTX ACTIVE TIME

(71) Applicant: SAMSUNG ELECTRONICS CO., LTD., Suwon-si (KR)

(72) Inventors: Sangkyu BAEK, Suwon-si (KR); Anil AGIWAL, Santa Clara, CA (US)

(21) Appl. No.: 18/894,445

(22) Filed: Sep. 24, 2024

Related U.S. Application Data
(60) Provisional application No. 63/585,437, filed on Sep. 26, 2023.

(51) Int. Cl. H04W 76/28

(52) U.S. Cl. CPC H04W 76/28

(57) ABSTRACT

The disclosure relates to a 5G or 6G communication system for supporting a higher data transmission rate. The disclosure relates to a method performed by a terminal and the method comprises receiving, from a base station, a radio resource control (RRC) message including configuration information associated with cell DTX, in case that the cell DTX is configured for a serving cell, identifying whether one of a first timer associated with discontinuous reception (DRX) retransmission of downlink (DL) or a second timer associated with DRX retransmission of uplink (UL) is running on any serving cell in a DRX group of the serving cell, and monitoring, in case that one of the first timer or the second timer is running, a physical downlink control channel (PDCCH) on the serving cell in the DRX group.

### CROSS REFERENCE TO RELATED APPLICATION

This application claims the benefit of U.S. Provisional Application No. 63/585,437, filed on Sep. 26, 2023, the disclosures of which are herein incorporated by reference in their entireties.

### BACKGROUND

### 1. Field

The disclosure relates to the operations of a user equipment (UE) and base station in a mobile communication system. The disclosure relates to a cell operation for a cell discontinuous transmission (DTX) active time.

### 2. Description of the Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The technical object to be achieved by various embodiments of the disclosure is to provide an efficient operation of a UE and base station in a mobile communication system. In addition, the technical objects to be achieved by various embodiments of the disclosure is to provide a method and apparatus related to a cell operation for a cell DTX active time.

According to an embodiment of the disclosure a method performed by a terminal in a wireless communication system is provided. The method comprises receiving, from a base station, a radio resource control (RRC) message including configuration information associated with cell discontinuous transmission (DTX), in case that the cell DTX is configured for a serving cell, identifying whether one of a first timer associated with discontinuous reception (DRX) retransmission of downlink (DL) or a second timer associated with DRX retransmission of uplink (UL) is running on any serving cell in a DRX group of the serving cell, and monitoring, in case that one of the first timer or the second timer is running, a physical downlink control channel (PDCCH) on the serving cell in the DRX group.

According to another embodiment of the disclosure a method performed by a base station in a wireless communication system is provided. The method comprises transmitting, to a terminal, a radio resource control (RRC) message including configuration information associated with cell discontinuous transmission (DTX) and transmitting, to the terminal, downlink control information on a physical downlink control channel (PDCCH) of the serving cell in a discontinuous reception (DRX) group, wherein, in case that the cell DTX is configured for a serving cell of the terminal, and one of a first timer associated with DRX retransmission of downlink (DL) or a second timer associated with DRX retransmission of uplink (UL) is running on any serving cell in the DRX group of the serving cell, the PDCCH is monitored.

According to another embodiment of the disclosure a terminal in a wireless communication system is provided. The method comprises a transceiver and at least one processor coupled with the transceiver and configured to receive, from a base station, a radio resource control (RRC) message including configuration information associated with cell discontinuous transmission (DTX), in case that the cell DTX is configured for a serving cell, to identify whether one of a first timer associated with discontinuous reception (DRX) retransmission of downlink (DL) or a second timer associated with DRX retransmission of uplink (UL) is running on any serving cell in a DRX group of the serving cell, and to monitor, in case that one of the first timer or the second timer is running, a physical downlink control channel (PDCCH) on the serving cell in the DRX group.

According to another embodiment of the disclosure a base station in a wireless communication system is provided. The base station comprises a transceiver and at least one processor coupled with the transceiver and configured to transmit, to a terminal, a radio resource control (RRC) message including configuration information associated with cell discontinuous transmission (DTX), and to transmit, to the terminal, downlink control information on a physical downlink control channel (PDCCH) of the serving cell in a discontinuous reception (DRX) group, wherein, in case that the cell DTX is configured for a serving cell of the terminal, and one of a first timer associated with DRX retransmission of downlink (DL) or a second timer associated with DRX retransmission of uplink (UL) is running on any serving cell in the DRX group of the serving cell, the PDCCH is monitored.

The technical problems to be achieved in the embodiments of the present disclosure are not limited to the technical problems mentioned above, and other technical problems not mentioned are clear to those skilled in the art from the description below. It will be understandable.

According to various embodiments of the disclosure, an efficient operation of a UE and base station in a mobile communication system can be provided.

In addition, according to various embodiments of the disclosure, a method and apparatus related to a cell operation for cell discontinuous transmission (DTX) active time can be provided.

The effects obtainable from the disclosure are not limited to the effects mentioned in the various embodiments, and other effects not mentioned can be clearly understood by a person skilled in the art to which the disclosure belongs from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a method for reducing network power consumption in a mobile communication system according to an embodiment of the present disclosure;

FIG. 2 illustrates an operation scheme of a cell DTX or cell DRX according to an embodiment of the present disclosure;

FIG. 3 illustrates an operation scheme of a cell DTX or cell DRX according to an embodiment of the disclosure present;

FIG. 4 illustrates a UE connected mode DRX operation by downlink data transmission and reception according to an embodiment of the present disclosure;

FIG. 5 illustrates a UE connected mode DRX operation by uplink data transmission and reception according to an embodiment of the present disclosure;

FIG. 6 illustrates a cross-carrier scheduling method according to an embodiment of the present disclosure;

FIG. 7 illustrates a PDCCH monitoring method when cell DTX and UE connected mode DRX are simultaneously configured according to an embodiment of the present disclosure;

FIG. 8 illustrates a PDCCH monitoring method when cell DTX and UE connected mode DRX are simultaneously configured according to an embodiment of the present disclosure;

FIG. 9 illustrates a PDCCH monitoring method when cell DTX and UE connected mode DRX are simultaneously configured according to an embodiment of the present disclosure;

FIG. 10 illustrates a PDCCH monitoring method when cell DTX and UE connected mode DRX are simultaneously configured according to an embodiment of the present disclosure;

FIG. 11 illustrates a method of monitoring PDCCH according to a cell DTX configuration and a random access operation according to an embodiment of the present disclosure;

FIG. 12 illustrates a structure of a base station according to an embodiment of the present disclosure; and

FIG. 13 illustrates a structure of a UE according to an embodiment of the present disclosure.

### DETAILED DESCRIPTION

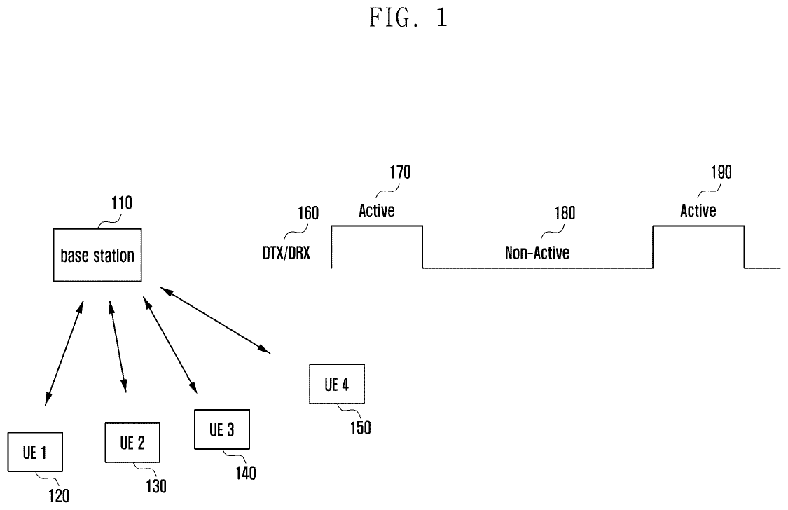

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

Hereinafter, a base station is an entity that allocates resources to a UE and may be at least one of a node B, a base station (BS), an eNode B (eNB), a gNode B (gNB), a radio access unit, a base station controller, and a node on a network. The UE may include a user equipment (UE), a mobile station (MS), a cellular phone, a smartphone, a computer, or a multimedia system capable of performing a communication function. Also, embodiments of the disclosure may be applied to other communication systems having a similar technical background or channel type to that of the embodiments of the disclosure. Also, the embodiments of the disclosure may also be applied to other communication systems through some modifications without significantly departing from the range of the disclosure based on determination of those skilled in the technical knowledge. For example, a 5th generation mobile communication technology (5G, new radio (NR)) developed after LTE-A may be included herein, and 5G may be a concept embracing the existing LTE and LTE-A and similar other services. Further, the disclosure may also be applied to other communication systems through some modifications without significantly departing from the range of the disclosure based on determination of those skilled in the technical knowledge.

Hereinafter, terms indicating an access node, terms indicating network entities or network functions (NFs), terms indicating messages, terms indicating an interface between network entities, terms indicating various pieces of identification information, and the like as used in the following description, are exemplified for convenience of explanation. Accordingly, the disclosure is not limited to the terms to be described later, but other terms indicating objects having equal technical meanings may be used.

Hereinafter, for convenience of explanation, some terms and names defined in 3rd generation partnership project (3GPP) long term evolution (LTE) standards and/or 3GPP new radio (NR) standards may be used. However, the disclosure is not limited to the above terms and names, and may also be applied to systems following other standards.

FIG. 1 illustrates a method for reducing network power consumption in a mobile communication system according to an embodiment of the present disclosure.

In a mobile communication system, a base station 110 provides a communication service to multiple UEs 120, 130, 140, and 150. Various UEs may be located in the coverage of one base station 110, and the base station 110 may provide communication services to these multiple UEs. Therefore, the base station 110 has relatively high power consumption compared to the UE. In addition, 5th generation (5G) mobile communication requiring high-speed transmission may have a higher bandwidth, higher transmission signal strength, and higher reception sensitivity to perform high-speed transmission, and thus this leads to high power consumption. Since the number of base stations managed by one mobile communication operator ranges from tens of thousands to hundreds of thousands of base stations, high power consumption of a communication network including a base station may increase management and maintenance costs of the mobile communication network. Therefore, a method for reducing power consumption of a communication network is required. Reduction of power consumption of a communication network may be achieved by the base station 110 temporarily cutting off the power of a transceiver. This is possible only when communication with the UE for which the base station 110 is to provide communication services is not being performed.

In the embodiment of FIG. 1, the base station 110 shows cell discontinuous transmission (DTX) and discontinuous reception (DRX) schemes that periodically cut off all or part of the power to a transceiver. Cell DTX indicates whether the power is cut off on the transmitter side (downlink) of the base station, and cell DRX indicates whether the power is cut off on the receiver side (uplink) of the base station. In the embodiment of FIG. 1, reference numeral 160 indicates a DTX or DRX state. In a case where the DTX or DRX state of the base station 110 is active (active time, 170), the base station 110 keeps the power of the transceiver turned on and performs procedures necessary for transmission and reception with the UE.

For example, the base station 110 may indicate resource allocation information on a physical downlink control channel (PDCCH) to allocate downlink resources to the UE and perform data transmission on a physical downlink shared channel (PDSCH). However, in a case where the base station 110 has no or little data to transmit and receive with the UE, the base station may switch the DTX/DRX state to non-active (non-active Time, 180) and cut off the power of the transceiver. In this case, in a case where the UE is aware of the DTX/DRX state of the base station 110, the UE may also cut off the power of its transceiver to reduce power consumption and avoid performing unnecessary communication procedures. This transition of the DTX/DRX state of the base station 110 may occur for a predefined time or may be changed by separate control information. In the embodiment of FIG. 1, it is illustrated that the DTX/DRX is repeated periodically. After the non-active time 180, the active time 190 may start again.

The base station 110 may cut off all transceiver power in the DTX/DRX non-active state 180, but in some embodiments, some of the transmission/reception functions of the base station 110 may be disabled to obtain a certain degree of power consumption reduction effect. For example, in the non-active state of the cell DTX, the transmission of downlink semi-persistent scheduling (SPS) that the base station 110 periodically transmits to the UE may be deactivated. In addition, in the non-active state of the cell transmission (TX), the UE may not monitor the physical downlink control channel (PDCCH) to which the base station allocates radio resources.

In some embodiments, in the cell DRX, the transmission of uplink configured grant (CG) that the UE transmits to the base station 110 may be deactivated so that the base station 110 does not receive the CG in the DRX non-active state. In this way, the base station 110 delivers to the UE whether to deactivate some transmission/reception functions, and the UE does not perform an operation corresponding to the function deactivated by the base station 110, thereby reducing unnecessary power consumption and preventing malfunction of the UE. The cell DTX and cell DRX may be configured separately, or may be configured simultaneously in one cell. In some embodiments, multiple cell DTXs and cell DRXs may be configured in one cell, and at most only one DTX and one DRX may be activated at a time. The base station 110 may transmit to the UE which cell DTX and cell DRX to activate or deactivate in the form of a layer-1 (L1) message of the physical layer or a layer-2 (L2) message of a medium access control (MAC) layer. The L1 message may be in the form of a downlink control information (DCI) in the PDCCH physical channel. The L2 message may be in the form of a medium access control (MAC) control element (CE) of the MAC layer.

The cell DTX or cell DRX may be configured independently for each cell. However, in a case where the base station 110 uses a technology such as carrier aggregation (CA) so that one base station has multiple cells, the cell DTX or cell DRX may have common configuration values in the multiple cells. In some embodiments, the multiple cells may be configured as a DRX group unit in which a connected state DRX of the UE is configured to reduce power consumption of the UE. This may have the effect of making it easy to perform a common operation when the connected state DRX of the UE and the cell DTX or cell DRX are configured at the same time. In some embodiments, the multiple cells may be configured as a cell group unit of the UE. The network power consumption reduction method and various concepts described in FIG. 1 may be applied to various embodiments of the disclosure.

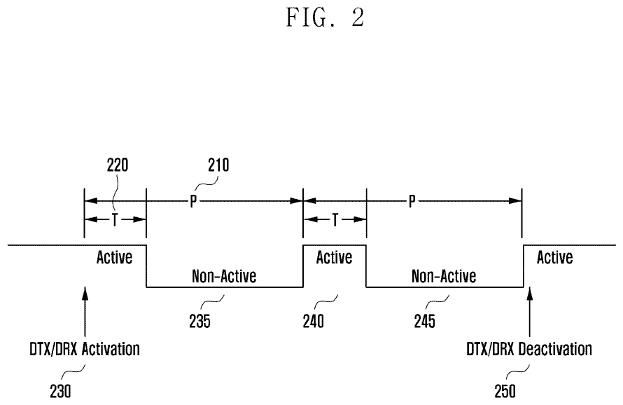

FIG. 2 illustrates an operation scheme of a cell DTX or cell DRX according to an embodiment of the present disclosure.

In the cell DTX/DRX defined to reduce power consumption of a base station, a UE may operate in a manner of periodically transitioning between an active state (Active Time) and a non-active state (non-active time). In some embodiments, the length of the active state may increase and the length of the non-active state may decrease depending on the amount of traffic that the base station may process. Such a cell DTX or cell DRX may be configured by the base station to the UE by a radio resource control (RRC) message.

In the embodiment of FIG. 2, a method is illustrated in which a base station configured with a cell DTX or cell DRX transmits a message (e.g., to identify the activation and deactivation as illustrated in 230, 250) to the UE to deliver whether to activate the configuration of the cell DTX or cell DRX. The UE is characterized in that it identifies the message (e.g., to identify the activation and deactivation as illustrated in 230, 250) of the base station through the PDCCH physical channel while the cell DTX is in the active state (active time) or cell DTX configuration is not activated and the UE activates the cell DTX/DRX configuration that periodically repeats the active state. In the embodiment of FIG. 2, it is assumed that a period in which the UE starts the on-duration that periodically starts the active state is P 210, and the on-duration time for transitioning to the active state is T 220. The values of P and T may be configured by being delivered from the base station through an RRC message. In addition, an offset value indicating the time point of starting the period P and on-duration T may also be configured from the base station.

When the UE receives a message indicating the activation of any cell DTX or cell DRX configuration (230), the UE may activate the indicated cell DTX or cell DRX operation for T time for each period P thereafter (220). Thereafter, the UE may transition to the non-active state at the end of the T time (235). Thereafter, at the start of the next cycle P, the UE may transition to the active state for T time and perform transmission and reception related to the base station (240). In the embodiment of FIG. 2, it is assumed that the UE does not receive a separate message at this time. Therefore, after T time, the UE may transition to the non-active state again (245). Thereafter, at the start of the cycle P, the UE may identify the message in the active state for T time. In the embodiment of FIG. 2, it is assumed that the UE is indicated by the base station to deactivate the cell DTX/DRX configuration and always maintain the active state (250). Thereafter, the UE may maintain the active time until the configuration of another cell DTX or cell DRX is activated. In some embodiments, the cell DTX/DRX information such as P and T values may be configured by the base station to the UE through an RRC message, but the message that the UE activates (230) or deactivates (250) the cell DTX/DRX configuration may be dynamically configured through MAC CE or DCI.

In the embodiment of FIG. 2, it is assumed that the cell DTX or cell DRX has a periodic pattern regardless of whether the operation is configured simultaneously or separately. However, the cell DTX and cell DRX may each have their own period and active state.

The definitions various terms and operations in the operation method of the cell DTX or cell DRX described through FIG. 2 may be applied to various embodiments of the disclosure.

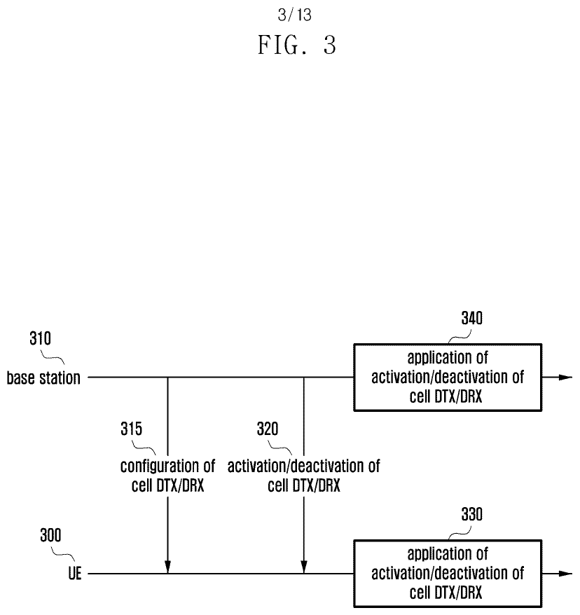

FIG. 3 illustrates an operation scheme of a cell DTX or cell DRX according to an embodiment of the present disclosure.

In order to reduce power consumption of a base station 310, the base station 310 may configure a cell DTX that periodically cuts off the transmission function of the base station or a cell DRX that periodically cuts off the reception function for each cell. In a case where the base station 310 configures the cell DTX or cell DRX and performs the corresponding operation, a UE 300 may not know the non-active state of the base station 310 and perform unnecessary transmission and reception operations, which may result in a deterioration of communication performance. To prevent this, the base station 310 may transmit to the UE 300 cell DTX or cell DRX (or both) configuration information applied in each cell.

In the configuration information of this cell DTX or cell DRX, only the cell DTX may be configured, only the cell DRX may be configured, or both the cell DTX and the cell DRX may be configured simultaneously. The configuration information of the cell DTX or cell DRX may include one or more of the period P, the on-duration length T, and the offset value at which the period and on-duration will start. In some embodiments, multiple cell DTXs and multiple cell DRXs may be configured for one cell. In a carrier aggregation state, a situation may also occur where multiple cells configured for the UE 300 have different cell DTXs and cell DRXs configured. However, at most one cell DTX configuration and one cell DRX configuration may be activated for one cell at a time. To this end, a message of operation 315 may indicate which cell DTX configuration or cell DRX configuration to activate. The message of operation 315 may be an RRC reconfiguration message.

Thereafter, in a case where the base station 310 wants to activate or deactivate a specific cell DTX configuration or cell DRX configuration, the base station 310 may transmit a cell DTX/DRX activation/deactivation message to the UE 300 to indicate activation or deactivation of the cell DTX configuration or cell DRX configuration (320). The message of operation 320 may be transmitted from the base station 310 to the UE 300 in the form of a layer-1 (L1) message of a physical layer or a layer-2 (L2) message of a MAC layer. The L1 message may be in the DCI format of a PDCCH physical channel. The L2 message may be in the MAC CE format of the MAC layer. Thereafter, the UE 300 and base station 310 may apply activation or deactivation of the cell DTX configuration or cell DRX configuration according to the information of the message transmitted in the operation 320 (330, 340). The message of operation 315 or operation 320 may include a starting time that indicates when the corresponding cell DTX or cell DRX is activated without immediately applying the cell DTX configuration and cell DRX configuration.

The operation and concept of cell DTX/DRX configuration, cell DTX/DRX activation/deactivation, and cell DTX/DRX application as illustrated in FIG. 3 may be applied to various embodiments of the disclosure.

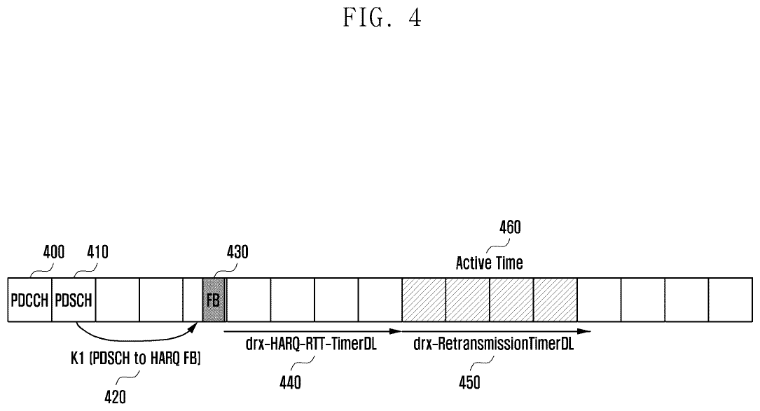

FIG. 4 illustrates a UE connected mode DRX operation by downlink data transmission and reception according to an embodiment of the present disclosure.

A UE in an RRC connected mode may be indicated of the location of a PDSCH physical channel 410 through which a base station transmits data to the UE on a PDCCH physical channel 400 and may receive data on the corresponding PDSCH physical channel. After receiving data (e.g., from the PDSCH 410), the UE may transmit to the base station a hybrid automatic repeat request (HARQ) feedback transmitting to the base station whether the corresponding data has been successfully received (430). In some embodiments, the HARQ feedback may be transmitted only for negative acknowledgement (NACK) feedback indicating that the HARQ feedback is configured or that reception has failed.

The time taken to transmit the HARQ feedback after receiving the data is called K1, and the K1 value may be configured in slot units (420). Specifically, HARQ feedback may be transmitted on the physical uplink control channel (PUCCH) physical channel resource configured in a slot after a K1 slot, from a slot in which the medium access control (MAC) protocol data unit (PDU) (or transport block (TB)) of data is received. The K1 value may configure a candidate group of possible K1 values through an RRC configuration, and may be configured by selecting one of the values of the candidate group in the PDSCH-to-HARQ_feedback timing indicator field of the DCI of the PDCCH channel that indicates scheduling of the MAC PDU (or TB) of data. The base station may configure a candidate group of K1 values in an RRC configuration message, and select one of the values of the candidate group in the DCI and indicate the same to the UE. Based on this, the UE may select the K1 value. In the embodiment of FIG. 4, the K1 value is configured to 3 slots, and the HARQ feedback is transmitted after 3 slots from the time when the MAC PDU of data (e.g., PDSCH 410) is received.

The PUCCH resource on which the HARQ feedback is transmitted may configure a candidate group of possible PUCCH resources by an RRC configuration, and may configure by selecting one value of the values of the candidate group in the PUCCH resource indicator field of the DCI of the PDCCH channel that indicates scheduling of the MAC PDU (or TB) of data. The base station may configure a candidate group of PUCCH resources to which HARQ feedback is transmitted in the RRC configuration message, and select one value of the candidate group in the DCI and indicate the same to the UE. Based on this, the UE may transmit HARQ feedback to the PUCCH resource to which the indicated HARQ feedback is transmitted.

In order to reduce power consumption of the UE receiving data, the base station may configure a UE connected mode DRX. The UE connected mode DRX may be configured by a DRX group in the MAC device of the UE. This may operate differently from the cell DTX or cell DRX configured by the base station unit. In a case where the UE connected mode DRX is configured, the values included in the corresponding DRX configuration may include DRX Cycle length, on-duration length (drx-onDurationTimer), drx-InactivityTimer length, drx-HARQ-RTT-TimerDL length, and drx-RetransmissionTimerDL length. When DRX is configured, the UE may have a certain amount of time of on-duration for each configured DRX cycle, and the on-duration may be operated by drx-onDurationTimer. The drx-InactivityTimer may be started when MAC PDU (TB) is received by cell-radio network temporary identifier (C-RNTI) or configured scheduling-radio network temporary identifier (CS-RNTI).

In addition, the UE may start drx-HARQ-RTT-TimerDL corresponding to the corresponding HARQ process that has received data in a first symbol after transmitting the HARQ feedback performed in an operation 430 (440). In a case where the base station indicates not to transmit HARQ feedback, or in a case where NACK-based HARQ feedback that transmits feedback only when data reception fails is configured and data reception is successfully performed and NACK is not created, drx-HARQ-RTT-TimerDL may not be started. After drx-HARQ-RTT-TimerDL expires, drx-RetransmissionTimerDL for the same HARQ process as the corresponding drx-HARQ-RTT-TimerDL may be started (450). drx-RetransmissionTimerDL may be started only in a case where the corresponding data is not successfully received (in a case where decoding of the corresponding TB fails).

Meanwhile, in a DRX operation, PDCCH monitoring using the corresponding C-RNTI and CS-RNTI may be performed only during the active time period, and PDCCH monitoring using the corresponding C-RNTI and CS-RNTI may be not performed when it is not the active time period, thereby reducing power consumption. In DRX, if at least one of the following conditions is satisfied, it may be considered as active time:
drx-onDurationTimer is running;
drx-InactivityTimer is running;
drx-RetransmissionTimerDL and drx-RetransmissionTimerUL are running;
ra-ContentionResolutionTimer or msgB-Response Window is running;
transmitted Scheduling Request is pending; an/or
Conditions set forth in various embodiments in which DRX is configured are satisfied.

In the embodiment of FIG. 4, during the period in which drx-RetransmissionTimerDL is running, the UE may perform PDCCH monitoring using C-RNTI and CS-RNTI in a cell in which the timer is configured, considering it as active time (460). This may have the effect of reducing the HARQ retransmission delay time after performing the previous transmission (e.g., on the PDSCH 410) by allowing the base station to perform retransmission when drx-RetransmissionTimerDL is running.

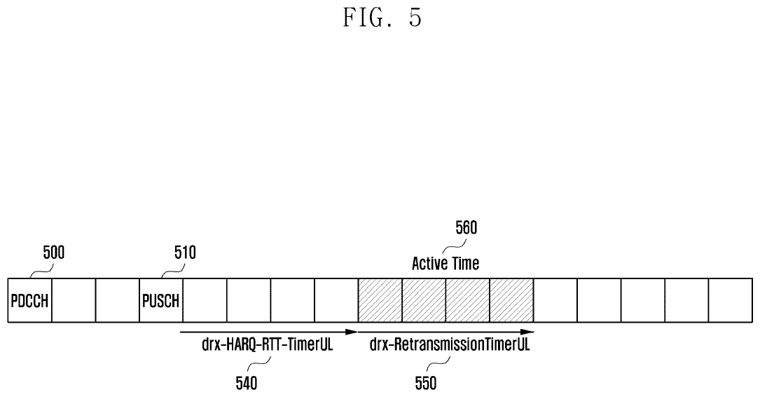

FIG. 5 illustrates a UE connected mode DRX operation by uplink data transmission and reception according to an embodiment of the present disclosure.

A UE in an RRC connected mode may be indicated of the location of a physical uplink shared channel (PUSCH) physical channel 510 through which a base station transmits data to the UE on a PDCCH physical channel 500 and may transmit data on the corresponding PUSCH physical channel. Meanwhile, for the purpose of reducing power consumption of the UE receiving data, the base station may configure a UE connected mode DRX to the UE. The UE connected mode DRX may be configured by DRX group in the MAC device of the UE. This may be operated differently from cell DTX or cell DRX configured by a base station unit. In a case where the UE connected mode DRX is configured, the values included in the corresponding DRX configuration may include DRX Cycle length, on-duration length (drx-onDurationTimer), drx-InactivityTimer length, drx-HARQ-RTT-TimerUL length, and drx-RetransmissionTimerUL length. When DRX is configured, the UE may have a certain amount of time of on-duration for each configured DRX cycle, and the on-duration may be operated by drx-onDurationTimer. If MAC PDU (TB) is received by C-RNTI or CS-RNTI, drx-InactivityTimer may be started.

In addition, the UE may start drx-HARQ-RTT-TimerUL corresponding to the corresponding HARQ process that has transmitted data in a first symbol after transmitting data to the base station on the PUSCH physical channel performed in an operation (e.g., PUSCH 510 and timer 540). Typically, the time length of drx-HARQ-RTT-TimerUL may be determined as the time required until transmitting the PDCCH that allocates retransmission resources if the base station performs decoding after the UE transmits the PUSCH to the base station and fails the decoding. After drx-HARQ-RTT-TimerUL expires, drx-RetransmissionTimerUL for the same HARQ process as the corresponding drx-HARQ-RTT-TimerUL may be started (550).

Meanwhile, in a DRX operation, PDCCH monitoring using the corresponding C-RNTI and CS-RNTI is performed only in the active time period, and PDCCH monitoring using the corresponding C-RNTI and CS-RNTI is not performed if it is not the active time period, thereby reducing power consumption. In DRX, if at least one of the following conditions is satisfied, it may be considered as active time:
drx-onDurationTimer is running;
drx-InactivityTimer is running;
drx-RetransmissionTimerDL and drx-RetransmissionTimerUL are running;
ra-ContentionResolutionTimer or msgB-Response Window is running;
transmitted Scheduling Request is pending; and/or
Conditions set forth in various embodiments in which DRX is configured are satisfied.

In the embodiment of FIG. 5, during a period in which drx-RetransmissionTimerUL is running, the UE may perform PDCCH monitoring using C-RNTI and CS-RNTI, considering it as active time in the cell in which the corresponding timer is configured (560). This may have the effect of reducing the HARQ retransmission delay time after performing the previous transmission (e.g., on the PUSCH 510) by allowing the base station to perform retransmission when drx-RetransmissionTimerUL is running.

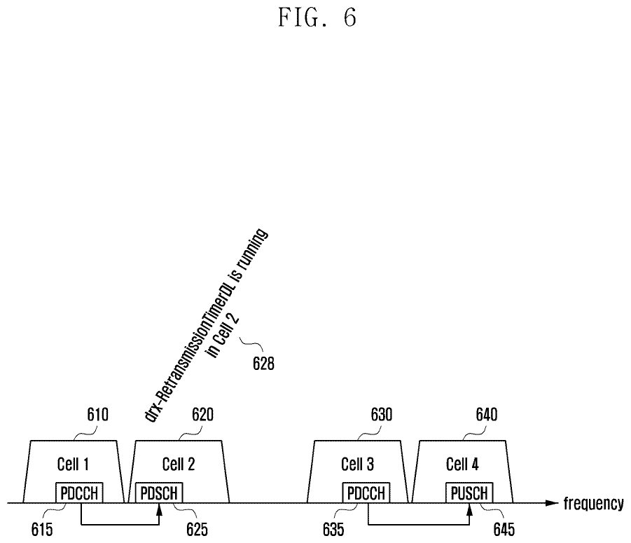

The downlink data reception operation of FIG. 5 and the uplink data transmission operation of FIG. 6 are distinguished only for the convenience of explanation, and the UE and base station of the disclosure may perform both the downlink-related operation of FIG. 5 and the uplink-related operation of FIG. 6, and may also be combined with other embodiments.

FIG. 6 illustrates a cross-carrier scheduling method according to an embodiment of the present disclosure.

A mobile communication service provider may use multiple frequency bands to provide mobile communication services, and a UE receiving the mobile communication service may perform mobile communication using these multiple frequency bands. By dividing various frequency bands into cells on a frequency axis (610, 620, 630, 640), the UE may be configured with multiple cells as serving cells. This process of providing communication services by configuring multiple cells in one UE is called carrier aggregation (CA). However, different cells may not necessarily have different frequencies, and in the case of Inter-Site CA where different base stations use the same frequency at different locations, it may be possible for the UE to be configured with the same frequency but different cells. In a single cell environment, rather than the CA, the uplink radio resource (or uplink grant) transmitted on the PUSCH and downlink radio resource (or downlink grant) transmitted on the PDSCH of the cell where the UE is configured may indicate resource allocation on the PDCCH physical channel of the corresponding cell, and the UE may monitor the corresponding PDCCH to identify whether there is a resource allocated to the UE.

In the CA environment, the cell that allocates radio resources on the PDCCH and the cell to which the actual PUSCH or PDSCH radio resources are allocated may be different. This may be applied in various ways in embodiments where the CA is applied due to issues with the capacity of the PDCCH, implementation of the base station scheduling device, etc. In the embodiment of FIG. 6, it is illustrated that the PDSCH resource 625 of cell 2 620 is allocated from the PDCCH 615 of cell 1 610, and the PUSCH resource 645 of cell 4 640 is allocated from the PDCCH 635 of cell 2 620. Transmitting the PUSCH or PDSCH resource of a corresponding cell from another cell in this way is called cross-carrier scheduling. In addition, in cross-carrier scheduling, the cell to which the PDCCH of that cell is transmitted may be called a scheduling cell. In the embodiment of FIG. 6, it is illustrated that the scheduling cell of cell 2 620 is cell 1 610, and the scheduling cell of cell 4 640 is cell 3 630. In some embodiments, some scheduling cells may include their own cells. Further, the scheduling cell of each cell may be configured by the base station to the UE through an RRC message that the base station configures to the UE.

If the UE connected mode DRX is configured to the UE, if drx-RetransmissionTimerDL or drx-RetransmissionTimerUL is running, all cells of all DRX groups for which the corresponding UE connected mode DRX is configured are considered as the active time of the UE connected mode DRX, and the UE may monitor the PDCCH physical channel during the corresponding time. Otherwise, if there is no drx-RetransmissionTimerDL or drx-RetransmissionTimerUL running in the cell of the DRX group for which the corresponding connected mode DRX is configured, the PDCCH physical channel is monitored in a case where other active time conditions are satisfied, and if other active time conditions are not satisfied, the UE does not need to monitor the PDCCH physical channel. In this case, if cell DTX is configured to multiple cells, even if drx-RetransmissionTimerDL or drx-RetransmissionTimerUL is running in a certain cell, the UE does not need to perform PDCCH monitoring if it is not a cell that may participate in the retransmission resource allocation of the corresponding timer.

Specifically, for a cell DTX that is configured and activated in a certain cell, in a case where it is not the active time of the cell DTX, it may be determined whether to perform PDCCH monitoring depending on whether drx-RetransmissionTimerDL and drx-RetransmissionTimerUL involved in the retransmission resource allocation in the corresponding cell are running. In the embodiment of FIG. 6, it is assumed that drx-Retransmission TimerDL is running 628 in cell 2 620, and it is assumed that the scheduling cell that performs resource allocation for the downlink radio resource of cell 2 620 is cell 1 610. In this case, since drx-RetransmissionTimerDL for the HARQ process of cell 2 620 is running 628, the UE may monitor the PDCCH of cell 1 610 even if it is not the active time of cell DTX. In some embodiments, in a case where the UE has the PDCCH of cell 2 620, the UE may also need to monitor the PDCCH of cell 2 620 in a case where drx-RetransmissionTimerDL or drx-RetransmissionTimerUL is running even if it is not the active time of cell DTX.

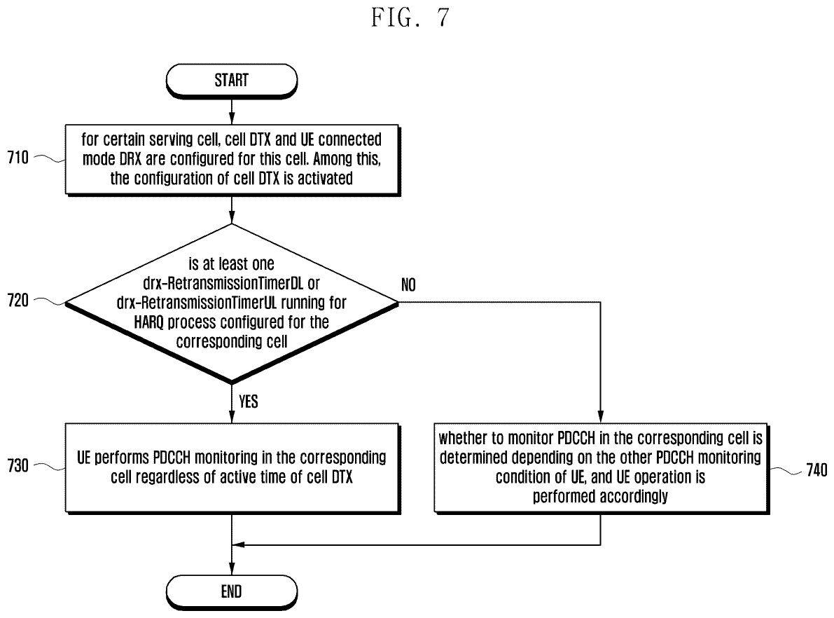

FIG. 7 illustrates a PDCCH monitoring method when cell DTX and UE connected mode DRX are simultaneously configured according to an embodiment of the present disclosure.

When a UE establishes an RRC connection with a base station, the base station may configure UE connected mode DRX to reduce power consumption of the UE. On the other hand, the base station may configure cell DTX to reduce power consumption of the base station. In this way, UE connected mode DRX and cell DTX of the base station may coexist and may be configured and operated for different purposes. In the case of cell DTX, it is possible to determine whether the base station performs downlink communication including PDCCH transmission, and when cell DTX is activated, in a case where it is not the active time (in the case of non-active time), the base station does not perform transmission on the PDCCH physical channel, so the UE may not perform PDCCH monitoring.

On the other hand, even in the UE connected mode DRX, in a case where it is not the active time of DRX (in the case of non-active time), the UE may not perform PDCCH monitoring. In this case, if it is not the active time of the UE connected mode DRX or the active time of the cell DTX, the UE may not perform PDCCH monitoring. However, in a case where it is not the active time of the cell DTX (non-active time), but the drx-Retransmission TimerDL or drx-RetransmissionTimerUL of the UE connected mode DRX is running, the UE may need to perform PDCCH monitoring because there is a possibility that HARQ retransmission may be allocated. In this case, it is not necessary to identify whether there is a drx-Retransmission TimerDL or drx-Retransmission TimerUL running for all serving cells, and identifying only whether the drx-RetransmissionTimerDL or drx-RetransmissionTimerUL for the cell involved in the retransmission of the corresponding cell is running may help prevent unnecessary PDCCH monitoring of the UE.

In the embodiment of FIG. 7, it is assumed that for a certain serving cell of the UE, both the cell DTX and the UE connected mode DRX are configured for this cell (710). Among these, it may be assumed that the configuration of the cell DTX is activated and performs an operation that periodically repeats the active time and non-active time as described in FIG. 1 or FIG. 2. Thereafter, the UE may identify whether at least one drx-Retransmission TimerDL or drx-RetransmissionTimerUL is running for the HARQ process configured for the corresponding cell.

If at least one drx-RetransmissionTimerDL or drx-RetransmissionTimerUL is running for the HARQ process configured for the corresponding cell, since this time is the time in which the base station may perform HARQ retransmission of the corresponding UE, the UE may perform PDCCH monitoring in the corresponding cell to receive the HARQ retransmission (e.g., operation 730). Regardless of whether this is the active time or non-active time of the cell DTX, the UE may perform PDCCH monitoring in the corresponding cell.

However, whether drx-Retransmission TimerDL or drx-RetransmissionTimerUL is running for the HARQ process configured in a cell other than the corresponding cell may not affect the operations of operations 720 and 730. If there is no drx-RetransmissionTimerDL or drx-RetransmissionTimerUL running for the HARQ process configured in the corresponding cell in an operation 720, this may not affect the PDCCH monitoring condition of the UE. In other words, whether to monitor PDCCH in the corresponding cell may be determined depending on the PDCCH monitoring condition of the UE configured in the cell DTX, and the UE operation may be determined accordingly (740). For example, as another UE monitoring condition, the UE may monitor PDCCH in the active time of the cell DTX and may not monitor PDCCH in the non-active time.

In some embodiments, in a case where at least one drx-RetransmissionTimerDL or drx-Retransmission TimerUL is running for the HARQ process configured for the corresponding cell, this may be considered as the active time of the cell DTX. In this case, the UE may perform PDCCH monitoring during the active Time period of the cell DTX.

In some embodiments, the base station may configure the UE to perform the operation of performing PDCCH monitoring only when the drx-RetransmissionTimerDL or drx-RetransmissionTimerUL of a specific cell as illustrated in FIG. 7 is running. This configuration may be configured through an RRC message transmitted from the base station to the UE.

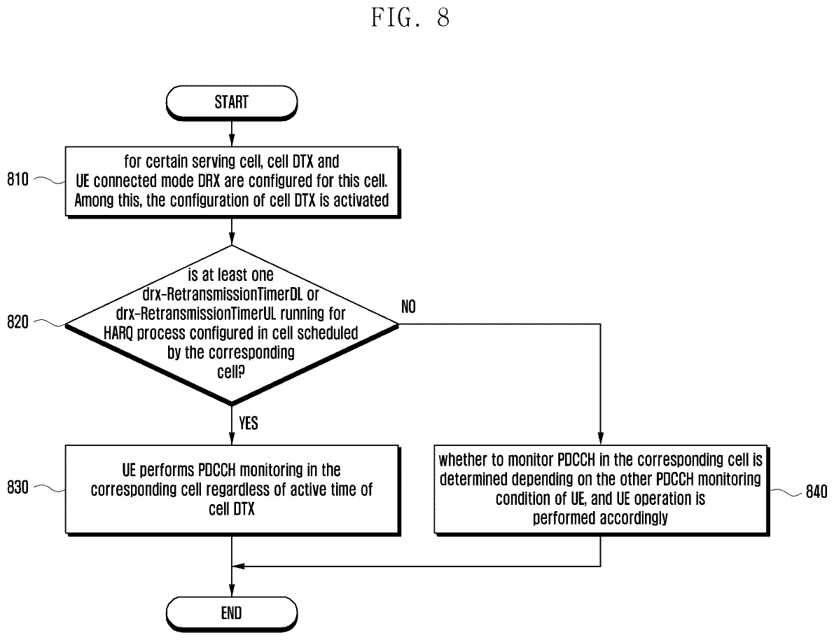

FIG. 8 illustrates a PDCCH monitoring method when cell DTX and UE connected mode DRX are simultaneously configured according to an embodiment of the disclosure.

When a UE establishes an RRC connection with a base station, the base station may configure UE connected mode DRX to reduce power consumption of the UE. On the other hand, the base station may configure cell DTX to reduce power consumption of the base station. In this way, UE connected mode DRX and cell DTX of the base station may coexist and may be configured and operated for different purposes. In the case of cell DTX, it is possible to determine whether the base station performs downlink communication including PDCCH transmission, and when cell DTX is activated, in a case where it is not the active time (in the case of non-active time), the base station does not perform transmission on the PDCCH physical channel, so the UE may not perform PDCCH monitoring. On the other hand, even in the UE connected mode DRX, in a case where it is not the active time of DRX (in the case of non-active time), the UE may not perform PDCCH monitoring. In this case, if it is not the active time of the UE connected mode DRX or the active time of the cell DTX, the UE may not perform PDCCH monitoring.

However, in a case where it is not the active time of the cell DTX (non-active time), but the drx-RetransmissionTimerDL or drx-RetransmissionTimerUL of the UE connected mode DRX is running, the UE may need to perform PDCCH monitoring because there is a possibility that HARQ retransmission may be allocated. In this case, it is not necessary to identify whether there is a drx-RetransmissionTimerDL or drx-RetransmissionTimerUL running for all serving cells, and identifying only whether the drx-RetransmissionTimerDL or drx-RetransmissionTimerUL for the cell involved in the retransmission of the corresponding cell is running may help prevent unnecessary PDCCH monitoring of the UE.

In the embodiment of FIG. 8, it is assumed that for a certain serving cell of the UE, both the cell DTX and the UE connected mode DRX are configured for this cell (810). Among these, it may be assumed that the configuration of the cell DTX is activated and performs an operation that periodically repeats the active time and non-active time as described in FIG. 1 or FIG. 2. Thereafter, the UE may identify whether at least one drx-Retransmission TimerDL or drx-RetransmissionTimerUL is running for the HARQ process configured in the cell scheduled by the corresponding cell.

If at least one drx-RetransmissionTimerDL or drx-RetransmissionTimerUL is running for the HARQ process configured in the cell scheduled by the corresponding cell, since this time is the time in which the base station may perform HARQ retransmission of the corresponding UE, the UE may perform PDCCH monitoring in the corresponding cell to receive the HARQ retransmission (in step 830). Regardless of whether this is the active time or non-active time of the cell DTX, the UE may perform PDCCH monitoring in the corresponding cell.

However, whether drx-Retransmission TimerDL or drx-RetransmissionTimerUL is running for the HARQ process configured in a cell other than the cell scheduled by the corresponding cell may not affect the operations of operations 820 and 830. If there is no drx-RetransmissionTimerDL or drx-RetransmissionTimerUL running for the HARQ process configured in the cell scheduled by the corresponding cell in an operation 820, this may not affect the PDCCH monitoring condition of the UE. In other words, whether to monitor PDCCH in the corresponding cell may be determined depending on the PDCCH monitoring condition of the UE configured in the cell DTX, and the UE operation may be determined accordingly (840). For example, as another UE monitoring condition, the UE may monitor PDCCH in the active time of the cell DTX and may not monitor PDCCH in the non-active time. For example, in the embodiment of FIG. 6, when the drx-RetransmissionTimerDL or drx-RetransmissionTimerUL of cell 1 and the drx-RetransmissionTimerDL or drx-RetransmissionTimerUL of cell 2 are running, the UE may perform PDCCH monitoring of cell 1.

In some embodiments, in a case where at least one drx-RetransmissionTimerDL or drx-RetransmissionTimerUL is running for the HARQ process configured in the cell scheduled by the corresponding cell, this may be considered as the active time of the cell DTX. In this way, the UE may perform PDCCH monitoring during the active time period of the cell DTX.

In some embodiments, the base station may configure the UE to perform the operation of performing PDCCH monitoring only when the drx-Retransmission TimerDL or drx-RetransmissionTimerUL of a specific cell illustrated in FIG. 8 is running. This configuration may be configured through an RRC message transmitted by the base station to the UE.

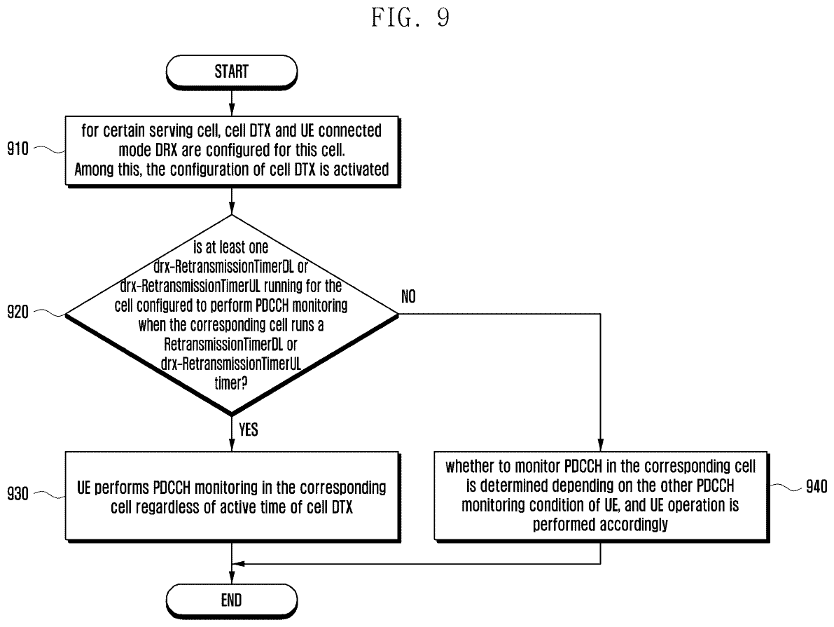

FIG. 9 illustrates a PDCCH monitoring method when cell DTX and UE connected mode DRX are simultaneously configured according to an embodiment of the present disclosure.

When a UE establishes an RRC connection with a base station, the base station may configure UE connected mode DRX to reduce power consumption of the UE. On the other hand, the base station may configure cell DTX to reduce power consumption of the base station. In this way, UE connected mode DRX and cell DTX of the base station may coexist and may be configured and operated for different purposes. In the case of cell DTX, it is possible to determine whether the base station performs downlink communication including PDCCH transmission, and when cell DTX is activated, in a case where it is not the active time (in the case of non-active time), the base station does not perform transmission on the PDCCH physical channel, so the UE may not perform PDCCH monitoring.

On the other hand, even in the UE connected mode DRX, in a case where it is not the active time of DRX (in the case of non-active time), the UE may not perform PDCCH monitoring. In this case, if it is not the active time of the UE connected mode DRX or the active time of the cell DTX, the UE may not perform PDCCH monitoring. However, in a case where it is not the active time of the cell DTX (non-active time), but the drx-RetransmissionTimerDL or drx-RetransmissionTimerUL of the UE connected mode DRX is running, the UE may need to perform PDCCH monitoring because there is a possibility that HARQ retransmission may be allocated. In this case, it is not necessary to identify whether there is a drx-Retransmission TimerDL or drx-RetransmissionTimerUL running for all serving cells, and identifying only whether the drx-RetransmissionTimerDL or drx-RetransmissionTimerUL for the cell involved in the retransmission of the corresponding cell is running may help prevent unnecessary PDCCH monitoring of the UE. The cell involved in the retransmission of this specific cell may be configured by the base station to the UE through an RRC message.

In some embodiments, when drx-RetransmissionTimerDL or drx-RetransmissionTimerUL is running instead of the cell involved in retransmission, the base station may configure the cell that performs PDCCH monitoring to the UE through an RRC message. For example, for cell 1, the base station may configure to the UE an inter-cell relationship that PDCCH monitoring may be performed in cell 1 when drx-RetransmissionTimerDL or drx-RetransmissionTimerUL of cell 1 and cell 2 are running.

In the embodiment of FIG. 9, it is assumed that for a certain serving cell of the UE, both the cell DTX and the UE connected mode DRX are configured for this cell (910). Among these, it may be assumed that the configuration of the cell DTX is activated and performs an operation that periodically repeats the active time and non-active time as described in FIG. 1 or FIG. 2. Thereafter, the UE may identify whether at least one drx-Retransmission TimerDL or drx-RetransmissionTimerUL is running for the HARQ process configured in the cell configured to perform PDCCH monitoring when the corresponding cell runs a Retransmission TimerDL or drx-RetransmissionTimerUL timer (in step 920).

If at least one drx-RetransmissionTimerDL or drx-RetransmissionTimerUL is running for the HARQ process configured in the cell configured to perform PDCCH monitoring when the corresponding cell runs RetransmissionTimerDL or drx-RetransmissionTimerUL timer, since this time is the time in which the base station may perform HARQ retransmission of the corresponding UE, the UE may perform PDCCH monitoring in the corresponding cell to receive the HARQ retransmission (in step 930). Regardless of whether this is the active time or non-active time of the cell DTX, the UE may perform PDCCH monitoring in the corresponding cell.

However, whether drx-Retransmission TimerDL or drx-RetransmissionTimerUL is running for the HARQ process configured in a cell other than the cell configured to perform PDCCH monitoring when the corresponding cell runs the RetransmissionTimerDL or drx-RetransmissionTimerUL timer may not affect the operations in the operations 920 and 930. If there is no drx-RetransmissionTimerDL or drx-Retransmission TimerUL running for the HARQ process configured in the cell that is configured to perform PDCCH monitoring when the corresponding cell runs the RetransmissionTimerDL or drx-RetransmissionTimerUL timer in an operation 920, this may not affect the PDCCH monitoring condition of the UE. In other words, whether to monitor PDCCH in the corresponding cell may be determined depending on the PDCCH monitoring condition of the UE configured in the cell DTX, and the UE operation may be determined accordingly (940).

In some embodiments, in a case where at least one drx-RetransmissionTimerDL or drx-RetransmissionTimerUL is running for the HARQ process configured in the cell configured to perform PDCCH monitoring when the corresponding cell runs the RetransmissionTimerDL or drx-RetransmissionTimerUL timer, this may be considered as the active time of the cell DTX. In this way, the UE may perform PDCCH monitoring during the active time period of the cell DTX.

In some embodiments, the base station may configure the UE to perform the operation of performing PDCCH monitoring only when the drx-Retransmission TimerDL or drx-RetransmissionTimerUL of a specific cell, as illustrated in FIG. 9, is running. This configuration may be configured through an RRC message transmitted from the base station to the UE.

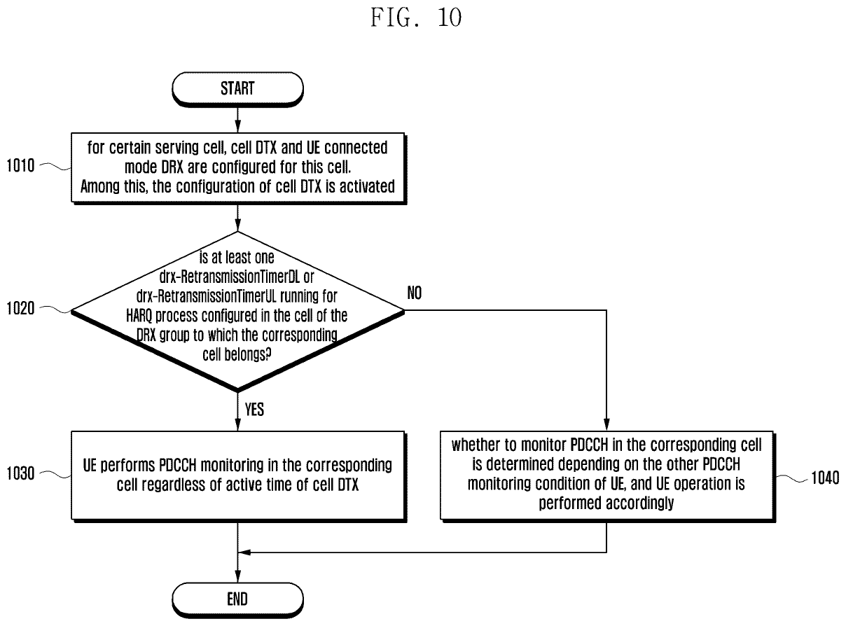

FIG. 10 illustrates a PDCCH monitoring method when cell DTX and UE connected mode DRX are simultaneously configured according to an embodiment of the present disclosure.

When a UE establishes an RRC connection with a base station, the base station may configure UE connected mode DRX to reduce power consumption of the UE. On the other hand, the base station may configure cell DTX to reduce power consumption of the base station. In this way, UE connected mode DRX and cell DTX of the base station may coexist and may be configured and operated for different purposes. In the case of cell DTX, it is possible to determine whether the base station performs downlink communication including PDCCH transmission. When cell DTX is activated, in a case where it is not the active time (in the case of non-active time), the base station does not perform transmission on the PDCCH physical channel, so the UE may not perform PDCCH monitoring. On the other hand, even in the UE connected mode DRX, in a case where it is not the active time of DRX (in the case of non-active time), the UE may not perform PDCCH monitoring.

In this case, if it is not the active time of the UE connected mode DRX or the active time of the cell DTX, the UE may not perform PDCCH monitoring. However, in a case where it is not the active time of the cell DTX (non-active time), but the drx-RetransmissionTimerDL or drx-RetransmissionTimerUL of the UE connected mode DRX is running, the UE may need to perform PDCCH monitoring because there is a possibility that HARQ retransmission may be allocated. In this case, it is not necessary to identify whether there is a drx-RetransmissionTimerDL or drx-RetransmissionTimerUL running for all serving cells, and identifying only whether the drx-RetransmissionTimerDL or drx-Retransmission TimerUL for the cell involved in the retransmission of the corresponding cell is running may help prevent unnecessary PDCCH monitoring of the UE. The cells involved in retransmission of this particular cell may be cells of the same DRX group.

In the embodiment of FIG. 10, it is assumed that for a certain serving cell of the UE, both the cell DTX and the UE connected mode DRX are configured for this cell (1010). Among these, it may be assumed that the configuration of the cell DTX is activated and performs an operation that periodically repeats the active time and non-active time as described in FIG. 1 or FIG. 2. Thereafter, the UE may identify whether at least one drx-RetransmissionTimerDL or drx-RetransmissionTimerUL is running for the HARQ process configured in the cell of the DRX group to which the corresponding cell belongs (1020).

If at least one drx-RetransmissionTimerDL or drx-RetransmissionTimerUL is running for the HARQ process configured in the cell of the DRX group to which the corresponding cell belongs, since this time is the time in which the base station may perform HARQ retransmission of the corresponding UE, the UE may perform PDCCH monitoring in the corresponding cell to receive the HARQ retransmission (1030). Regardless of whether this is the active time or non-active time of the cell DTX, the UE may perform PDCCH monitoring in the corresponding cell.

However, whether drx-Retransmission TimerDL or drx-RetransmissionTimerUL is running for the HARQ process configured in a cell other than the cell of the DRX group to which the corresponding cell belongs may not affect the operations of operations 1020 and 1030. If there is no drx-RetransmissionTimerDL or drx-RetransmissionTimerUL running for the HARQ process configured in the cell of the DRX group to which the corresponding cell belongs in an operation 1020, this may not affect the PDCCH monitoring condition of the UE. In other words, whether to monitor PDCCH in the corresponding cell may be determined depending on the PDCCH monitoring condition of the UE configured in the cell DTX, and the UE operation may be determined accordingly (1040). In some embodiments, in a case where at least one drx-RetransmissionTimerDL or drx-RetransmissionTimerUL is running for the HARQ process configured in a cell of the DRX group to which the corresponding cell belongs, this may be considered as the active time of the cell DTX. This allows the UE to perform PDCCH monitoring during the active time period of the cell DTX.

In some embodiments, the base station may configure the UE to perform the operation of performing PDCCH monitoring only when the drx-RetransmissionTimerDL or drx-RetransmissionTimerUL of a specific cell as illustrated in FIG. 10 is running. This configuration may be configured through an RRC message transmitted from the base station to the UE.

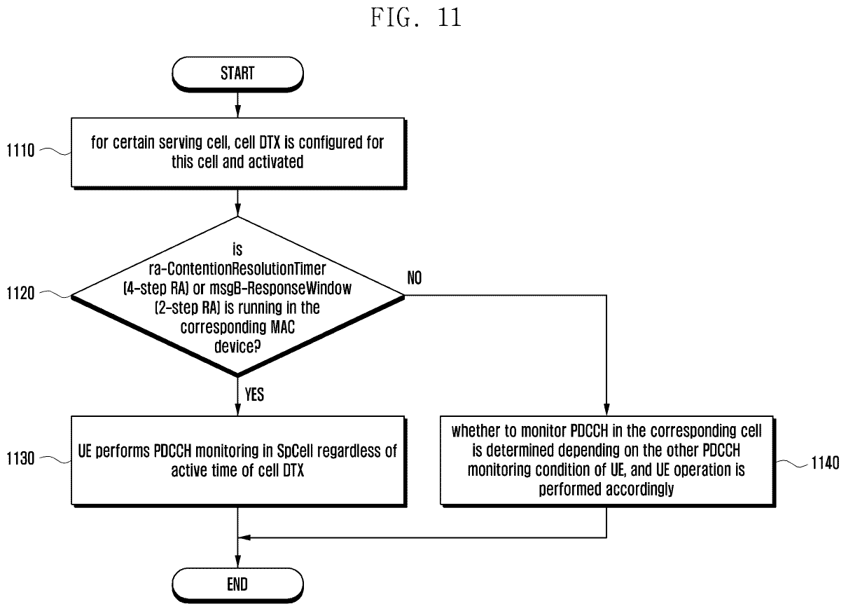

FIG. 11 illustrates a method of monitoring PDCCH according to a cell DTX configuration and a random access operation according to an embodiment of the present disclosure.

The base station may configure the cell DTX to reduce power consumption of the base station. In the case of the cell DTX, the base station may determine whether to perform downlink communication including PDCCH transmission, and when the cell DTX is activated, in a case where it is not the active time (in the case of non-active time), the base station does not perform transmission on the PDCCH physical channel, so the UE may not perform PDCCH monitoring. In a case where the UE is not in the active time of the cell DTX (non-active time), but the ra-ContentionResolutionTimer for receiving message 4 in the 4-step random access or the msgB-Response Window for receiving message B in the 2-step random access is running, the UE may perform PDCCH monitoring because there is a possibility that the corresponding random access related message may be allocated. In this case, it is not necessary to monitor the PDCCH of all serving cells, and performing PDCCH monitoring only for cells where contention-based random access is performed may help prevent unnecessary PDCCH monitoring of the UE.

In the embodiment of FIG. 11, it is assumed that for a certain serving cell of the UE, the cell DTX is configured and activated for this cell (1110). Thereafter, the UE may identify whether ra-ContentionResolutionTimer or msgB-ResponseWindow is running in the corresponding MAC device (1120).

If it is possible to identify whether ra-ContentionResolutionTimer or msgB-Response Window is running in the corresponding MAC device, since this time is a time when the base station may indicate the corresponding UE to transmit message 4 or message B, the UE may perform PDCCH monitoring in the SpCell (PCell in case of master cell group, PSCell in case of Secondary Cell Group) of the corresponding MAC device (1130). Regardless of whether it is the active time or the non-active time of the cell DTX, the UE may perform PDCCH monitoring in the SpCell.

However, in the SCell other than the SpCell, whether ra-ContentionResolutionTimer or msgB-ResponseWindow is running in the corresponding MAC device may not affect the operations in operations 1120 and 1130. If ra-ContentionResolutionTimer or msgB-ResponseWindow is not running in the corresponding MAC device in an operation 1120, this may not affect the PDCCH monitoring conditions of the UE. In other words, whether to monitor PDCCH in the corresponding cell may be determined depending on the PDCCH monitoring conditions of the UE configured in the cell DTX, and the UE operation may be determined accordingly (1140). For example, as another UE monitoring condition, the UE may monitor PDCCH in the active time of the cell DTX and may not monitor PDCCH in the non-active time.

In some embodiments, in a case where the ra-ContentionResolutionTimer or msgB-Response Window is running in the corresponding MAC device, the SpCell may consider it as the active time of the cell DTX. In this case, the UE may perform PDCCH monitoring during the active time period of the cell DTX.

Meanwhile, in FIGS. 7 to 11, each embodiment is described separately for convenience of explanation, and it should be noted that the operations of each embodiment may be combined and implemented within a non-contradictory range.

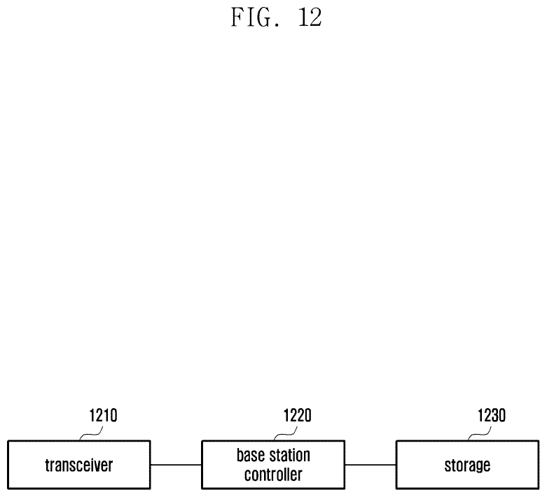

FIG. 12 illustrates a structure of a base station according to an embodiment of the disclosure.

With reference to FIG. 12, a base station may include a transceiver 1210, a base station controller 1220, and a storage 1230. The base station controller 1220 may be defined as a controller 1220. In the disclosure, the controller 1220 may be defined as a circuit or an application-specific integrated circuit or at least one processor. The transceiver 1210 may transmit and receive signals with other network entities. The transceiver 1210 may transmit system information to a UE, for example, and may transmit a synchronization signal or a reference signal. Through the transceiver 1210, the base station may transmit and/or receive signals, information, data, and messages. The controller 1220 may control the overall operation of the base station according to the embodiment provided in the disclosure. For example, the controller 1220 may control the signal flow between respective blocks to perform an operation according to the flowchart described above. The storage 1230 may store at least one of the information transmitted and received through the transceiver 1210 and the information generated through the controller 1220.

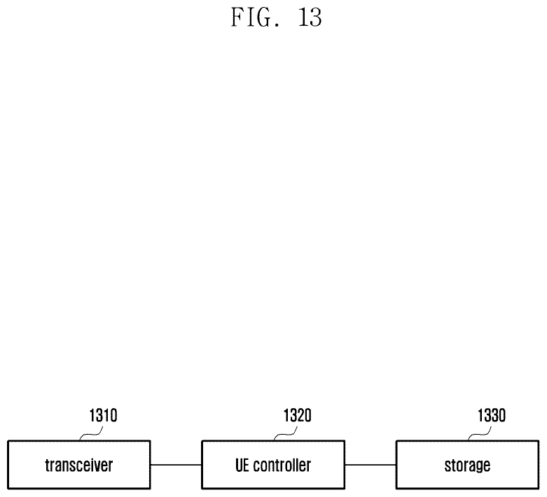

FIG. 13 illustrates a structure of a UE according to an embodiment of the disclosure.

With reference to FIG. 13, the UE may include a transceiver 1310, a UE controller 1320, and a storage 1330. The UE controller 1320 may be defined as a controller 1320. In the disclosure, the controller 1320 may be defined as a circuit or an application-specific integrated circuit or at least one processor. The transceiver 1310 may transmit and receive signals with other network entities. The transceiver 1310 may receive system information from a base station, for example, and may receive a synchronization signal or a reference signal. Through the transceiver 1310, the UE may transmit and/or receive signals, information, data, and messages. The controller 1320 may control the overall operation of the UE according to the embodiment provided in the disclosure. For example, the controller 1320 may control the signal flow between respective blocks to perform operations according to the flowchart described above. The storage 1330 may store at least one of the information transmitted and received through the transceiver 1310 and the information generated through the controller 1320.

The methods according to the embodiments of the disclosure described in the specification or the claims may be implemented by hardware, software, or a combination thereof.

In a case where the methods are implemented by software, a computer-readable storage medium may be provided to store one or more programs (software modules). The one or more programs stored in the computer-readable storage medium may be configured for execution by one or more processors in an electronic device. The one or more programs may include instructions for causing the electronic device to execute the methods according to the embodiments of the disclosure described in the specification or the claims.

These programs (software modules or software) may be stored in random access memories, nonvolatile memories including flash memories, read only memories (ROMs), electrically erasable programmable ROMs (EEPROMs), magnetic disc storage devices, compact disc-ROMs (CD-ROMs), digital versatile discs (DVDs), other types of optical storage devices, or magnetic cassettes. Also, the programs may be stored in a memory constituted by a combination of some or all of such storage devices. Also, each of the constituent memories may be provided in plurality.

Also, the programs may be stored in an attachable storage device that may be accessed through a communication network such as Internet, Intranet, local area network (LAN), wide LAN (WLAN), or storage area network (SAN), or through a communication network constituted by any combination thereof. Such a storage device may be connected through an external port to an apparatus performing an embodiment of the disclosure. Also, a separate storage device on a communication network may be connected to an apparatus performing an embodiment of the disclosure.

In the above particular embodiments of the disclosure, the components included in the disclosure are expressed in the singular or plural according to the presented particular embodiments. However, the singular or plural expressions are selected suitably according to the presented situations for convenience of description, the disclosure is not limited to the singular or plural components, and the components expressed in the plural may even be constituted in the singular or the components expressed in the singular may even be constituted in the plural.

Meanwhile, the embodiments of the disclosure disclosed in this specification and drawings are only specific examples to easily explain the technical content of the disclosure and help understand the disclosure, and are not intended to limit the scope of the disclosure. That is, it is obvious to a person skilled in the art to which the disclosure pertains that other modified examples based on the technical idea of the disclosure are possible. In addition, each of the above embodiments can be combined and operated with each other as needed. For example, parts of one embodiment of the disclosure and another embodiment can be combined with each other to operate a base station and UE. In addition, the embodiments of the disclosure can be applied to other communication systems, and other modified examples based on the technical idea of the embodiments can also be implemented.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a radio resource control (RRC) message including configuration information associated with a cell discontinuous transmission (DTX);
in case that the cell DTX is configured for a serving cell, identifying whether one of a first timer associated with a discontinuous reception (DRX) retransmission of downlink (DL) or a second timer associated with a DRX retransmission of uplink (UL) is running on any serving cell in a DRX group of the serving cell; and
monitoring, in case that one of the first timer or the second timer is running, a physical downlink control channel (PDCCH) on the serving cell in the DRX group.

2. The method of claim 1, wherein the first timer comprises a drx-RetransmissionTimerDL and the second timer comprises a drx-RetransmissionTimerUL.

3. The method of claim 1, wherein an activation of the cell DTX for the serving cell is indicated based on downlink control information (DCI) or the RRC message including the configuration information associated with the cell DTX.

4. The method of claim 1, wherein the PDCCH on the serving cell is monitored on serving cells of the DRX group regardless of an active time or non-active time for the cell DTX.

5. The method of claim 1, wherein, in case that both of the first timer and the second timer are not running, the PDCCH is monitored on the serving cell in an active time for the cell DTX.

6. A method performed by a base station in a wireless communication system, the method comprising:
transmitting, to a terminal, a radio resource control (RRC) message including configuration information associated with a cell discontinuous transmission (DTX); and
transmitting, to the terminal, downlink control information on a physical downlink control channel (PDCCH) of a serving cell in a discontinuous reception (DRX) group,
wherein, in case that the cell DTX is configured for the serving cell of the terminal and one of a first timer associated with DRX retransmission of downlink (DL) or a second timer associated with DRX retransmission of uplink (UL) is running on any serving cell in the DRX group of the serving cell, the PDCCH is monitored.

7. The method of claim 6, wherein the first timer comprises a drx-RetransmissionTimerDL and the second timer comprises a drx-RetransmissionTimerUL.

8. The method of claim 6, wherein an activation of the cell DTX for the serving cell is indicated based on downlink control information (DCI) or the RRC message including the configuration information associated with the cell DTX.

9. The method of claim 6, wherein the PDCCH on the serving cell is monitored on serving cells of the DRX group regardless of an active time or non-active time for the cell DTX.

10. The method of claim 6, wherein, in case that both of the first timer and the second timer are not running, the PDCCH is monitored on the serving cell in an active time for the cell DTX.

11. A terminal in a wireless communication system, the terminal comprising:
a transceiver; and
at least one processor coupled with the transceiver and configured to:
receive, from a base station, a radio resource control (RRC) message including configuration information associated with cell discontinuous transmission (DTX),
in case that the cell DTX is configured for a serving cell, identify whether one of a first timer associated with a discontinuous reception (DRX) retransmission of downlink (DL) or a second timer associated with a DRX retransmission of uplink (UL) is running on any serving cell in a DRX group of the serving cell, and
monitor, in case that one of the first timer or the second timer is running, a physical downlink control channel (PDCCH) on the serving cell in the DRX group.

12. The terminal of claim 11, wherein the first timer comprises a drx-RetransmissionTimerDL and the second timer comprises a drx-RetransmissionTimerUL.

13. The terminal of claim 11, wherein an activation of the cell DTX for the serving cell is indicated based on downlink control information (DCI) or the RRC message including the configuration information associated with the cell DTX.

14. The terminal of claim 11, wherein the PDCCH on the serving cell is monitored on serving cells of the DRX group regardless of an active time or non-active time for the cell DTX.

15. The terminal of claim 11, wherein, in case that both of the first timer and the second timer are not running, the PDCCH is monitored on the serving cell in an active time for the cell DTX.

16. A base station in a wireless communication system, the base station comprising:
a transceiver; and
at least one processor coupled with the transceiver and configured to:
transmit, to a terminal, a radio resource control (RRC) message including configuration information associated with a cell discontinuous transmission (DTX), and
transmit, to the terminal, downlink control information on a physical downlink control channel (PDCCH) of a serving cell in a discontinuous reception (DRX) group,
wherein, in case that the cell DTX is configured for the serving cell of the terminal and one of a first timer associated with DRX retransmission of downlink (DL) or a second timer associated with DRX retransmission of uplink (UL) is running on any serving cell in the DRX group of the serving cell, the PDCCH is monitored.

17. The base station of claim 16, wherein the first timer comprises a drx-RetransmissionTimerDL and the second timer comprises a drx-RetransmissionTimerUL.

18. The base station of claim 16, wherein an activation of the cell DTX for the serving cell is indicated based on downlink control information (DCI) or the RRC message including the configuration information associated with the cell DTX.

19. The base station of claim 16, wherein the PDCCH on the serving cell is monitored on serving cells of the DRX group regardless of an active time or non-active time for the cell DTX.

20. The base station of claim 16, wherein, in case that both of the first timer and the second timer are not running, the PDCCH is monitored on the serving cell in an active time for the cell DTX.
